(19) United States
(12) Patent Application Publication
(10) Pub. No.: US 2005/0175035 A1
(43) Pub. Date: Aug. 11, 2005

(54) Method and system for providing DOCSIS service over a passive optical network

(76) Inventors: Kevin Neely, Duluth, GA (US); George Bodeep, Suwanee, GA (US)

Correspondence Address: ARRIS INTERNATIONAL, INC, 3871 LAKEFIELD DRIVE, SUWANEE, GA, 30024, US

(21) Appl. No.: 11/053,701

(22) Filed: Feb. 7, 2005

Related U.S. Application Data
(63) Continuation of application No. 10/982,211, filed on Nov. 5, 2004.
(60) Provisional application No. 60/521,025, filed on Feb. 6, 2004.

(51) Int. Cl. H04L 12/56

(52) U.S. Cl. 370/486

(57) ABSTRACT

A passive optical network used to transport traffic signals between a head end and subscriber equipment increases performance and reduces costs while potentially allowing the retention of legacy equipment at the head end and at the subscriber's cable modem. Upstream and downstream traffic signals are converted to upstream and downstream optical wavelengths at customer equipment and head end equipment, respectively, and transported across the PON. The optical signals are converted to electrical signals at the other respective ends, or edges, of the PON, and DOCSIS operation and processing occurs as known in the art. Upstream traffic can be carried at unconventional upstream frequencies. The upper frequency limit of traffic signals is higher than for an HFC, thus providing for potentially more channels, either upstream or downstream.

### CROSS REFERENCE TO RELATED APPLICATION

This application claims priority under 35 U.S.C. 119(e) to U.S. provisional patent application No. 60/521,025 entitled “DOCSIS PON,” which was filed Feb. 6, 2004, and is incorporated herein by reference in its entirety. This application also claims priority under 35 U.S.C. 120 to U.S. patent application Ser. No. 10/982,211 entitled “Method and system for providing video and data traffic packets from the same device,” which was filed Nov. 5, 2004, and is incorporated herein by reference in its entirety.

### FIELD OF THE INVENTION

This invention relates, generally, to communication networks and devices and, more particularly, to providing DOCSIS service over a passive optical network.

### BACKGROUND

Cable television operators, often referred to as Multiple Services Operators (“MSO”), not only broadcast television network program content to their subscribers, but also deliver internet data, video on demand and either constant bit rate or internet protocol voice traffic. The primary network type for delivering these traffic delivery services is a hybrid fiber coaxial network (“HFC”), which uses the legacy coaxial networks that have been in place in some areas since the 1960s for delivering analog television content. While this networking system is functional, the increasing bandwidth requirements of services such as high definition television (“HDTV”), video on demand, video conferencing etc., are bringing the HFC plant to operate near its technical capacity. Moreover, if the HFC plant is not immaculately maintained, ingress and egress noise, due to corroded connectors and compromised cable, can reduce available bandwidth below the design capabilities of the HFC plant. Thus, the practical limit of available bandwidth is reduced, which may cause MSOs to forgo adding additional HDTV channels and other services, may cause a reduction in traffic transport performance, including latency which is a critical parameter for voice call traffic for example, or both. Furthermore, a poorly maintained HFC network can cause frequent and unpredictable plant outages that interrupt service making it unsuitable for critical business applications.

Ingress noise tends to affect the lower frequency range—typically 5-42 MHz—used for upstream DOCSIS traffic streams. Not only does the noise impede performance, but also the narrow range compared with the downstream frequencies does not allow for as much upstream traffic as downstream. When DOCSIS was first conceived, this was fine, since most data traffic was Internet traffic, where there tended to be more traffic in the downstream direction than in the upstream. However, as video conferencing, for example, becomes more widespread, users are beginning to run into bandwidth limitations in the upstream direction.

Furthermore, HFC plants use amplifiers between the cable head end and the users to boost signal strength due to signal loss that increases proportionally with the distance a signal travels from its source. Thus, these amplifiers increase capital costs, and since they are typically powered by 60 Hz AC current, incur power supply costs and maintenance costs to ensure safety and reliability. In addition, these electrical amplifiers tend to have a natural frequency response roll-off about 800 MHz. This roll-off point may be further lowered by poor maintenance of the cable plant, as discussed above in reference to ingress noise, as well as natural roll-off due to the coaxial cable itself. Thus, the effective upper frequency limit of a typical coaxial cable plant may be 700 MHz or less, thus limiting the number of downstream channels available for delivering various types of traffic streams.

These problems have led to the building of Fiber-to-the-Home networks to serve business and residential customers with greater bandwidth, lower maintenance costs and greater reliability than traditional copper networks. However, the existing Passive Optical Network (“PON”) technology that such networks are based on is difficult for operators to deploy as it uses different protocols from those presently in use in MSO's networks, and requires substantial investment in additional equipment to translate the protocols, in software to control and manage the equipment, and in training to adapt their system of working to the new equipment and software. Furthermore, current PON technology only provides the ability to offer data services, and does not allow operators to provide video and voice services over the same network.

Therefore there is a need on the art for a method and system for delivering multiple services from a head-end to customers/subscribers that increases available bandwidth and service reliability in the upstream and downstream directions, while using protocols and systems that are already in use in the MSO's networks, thereby allowing an MSO to retain and continue to use their existing head-end equipment and software systems. Furthermore, there is a need for a method and system that reduces maintenance costs and improves service reliability as compared to existing HFC plants.

### SUMMARY

A method and system for transporting multiple services traffic signals over a passive optical network (“PON”) increases performance and reduces costs while allowing an MSO to retain legacy equipment at the head end and at the subscriber's cable modem. Upstream and downstream traffic signals are converted to upstream and downstream optical wavelengths at customer equipment and head end equipment, respectively, and transported across the PON. The optical signals are converted to electrical signals at the other respective ends, or edges, of the PON, and DOCSIS operation and processing continues as known in the art. Thus, ingress noise affects traffic to a significantly less extent as compared with an HFC and reliability and available bandwidth—both upstream and downstream—is increased.

### BRIEF DESCRIPTION OF DRAWINGS

FIG. 1 illustrates a system for transporting multiple types of traffic signals over a passive optical network.

FIG. 2 illustrates an optical network interface device.

FIG. 3 illustrates a system using baseband PHY.

FIG. 4 illustrates a system using upconverted upstream QAM frequencies for transport over a PON.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. The following disclosure is not intended nor is to be construed to limit the present invention or otherwise to exclude any such other embodiments, adaptations, variations, modifications and equivalent arrangements, the present invention being limited only by the claims appended hereto and the equivalents thereof.

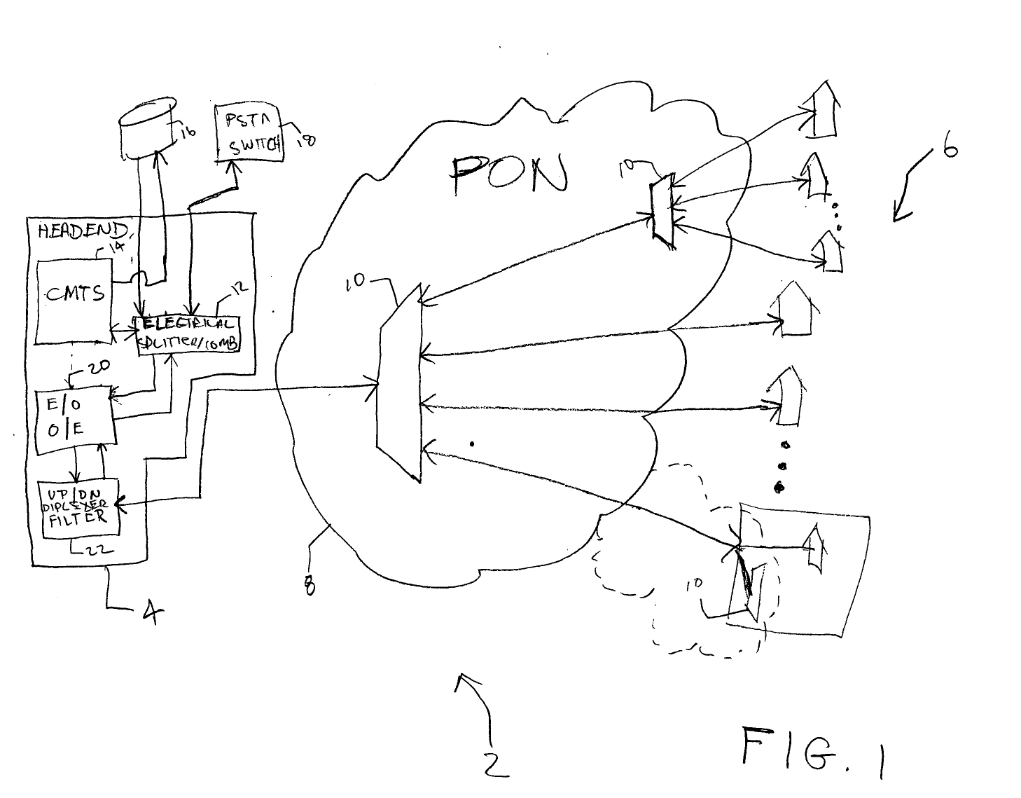

Turning to the figures, FIG. 1 illustrates a system 2 for transporting traffic between a head end 4 and user/subscribers 6 over a passive optical network (“PON”) 8. PON 8 typically includes one or more splitters 10 that replicate an optical signal in the downstream direction into a plurality of signals that are essentially duplicates of the incoming signals, but at typically lower signal strength due to the splitting process, as known in the art. Splitter 10 is also capable of receiving a plurality of signals in the upstream direction and combining them into an upstream composite signal that is output at the other side of the splitter. Thus, splitter 10 may be referred to as a splitter/combiner depending on the direction of signals being referred to. Signals are conventionally referred to in the art as downstream when they travel from the head end 4 toward the users 6, and upstream when they travel from the users toward the head end.

Upstream and downstream traffic may include DOCSIS data traffic, video traffic, such as broadcast television signals or video on demand, for example and telephony traffic. In the downstream directions these signals are received at an electrical signal combiner 12, from CMTS 14, video server 16 and/or PSTN switch. Combiner 2 may use frequency division multiplexing (“FDM”) to combine these various types of signals into a composite electrical downstream signal. It will be appreciated that electrical signal combiner 12 may be, or may include, the combined transmission device described in U.S. patent application Ser. No. 10/982,211.

The composite electrical downstream signal is then converted from an electrical signal to an optical signal by converter 20 at a predetermined downstream wavelength. This predetermined downstream signal wavelength is preferably compatible with the International Telecommunication Union (“ITU”) G.983 standard, as known in the art. The downstream signal is then passed through filter 22, also referred to as an optical diplexer that is configured to pass signals at the predetermined downstream wavelength in the downstream direction to PON 8.

Downstream optical signals are received at the subscriber's premises by an optical network interface unit (“ONI”), which will be described further in reference to other figures. The ONI converts the optical signal to an electrical signal, and separates the various types of signals from one another. After the signals have been separated and isolated from one another, they are output from corresponding outputs, for example, DOCSIS data is provided at an Ethernet data output, for connection to a computer or similar device. The downstream and upstream signals may be combined with an electrical diplexer and passed from the ONI as an electrical signal to a stand-alone cable modem from a duplex RF F-connector. Television signals are preferably output from a pass through F-connector for connection to a set top box (“STB”), or directly to a television. Telephony signals may be output from a telephony output, with, for example, an RJ-11 jack, for connection to one or more telephones.

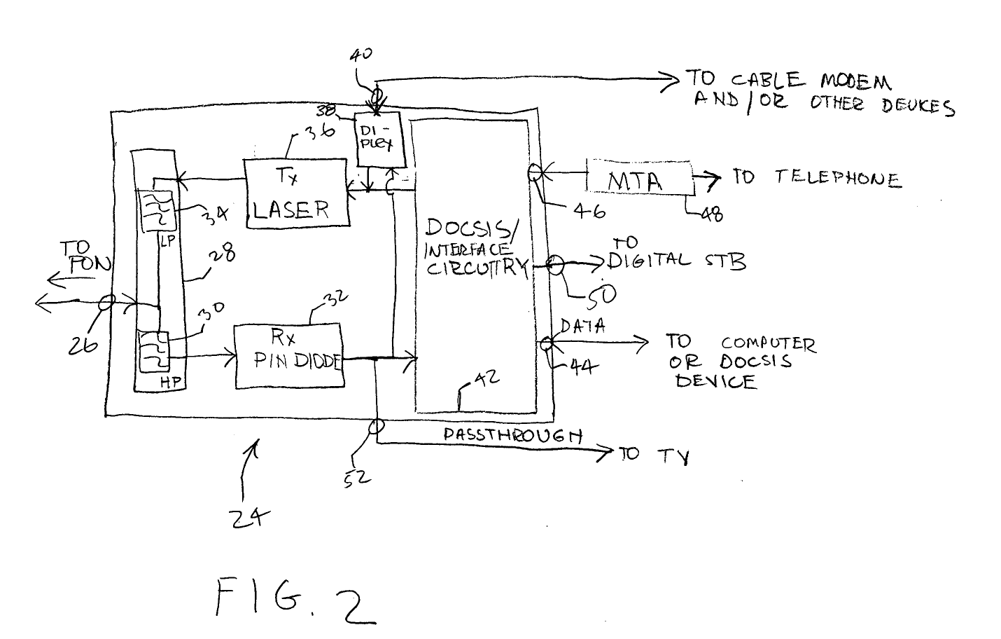

Turning now to FIG. 2, an illustration of an optical network interface device (“ONI”) 24. PON connection 26 accepts an optical fiber connected to PON 8 shown in FIG. 1, and is coupled to optical diplexer 28. An optical high pass filter 30 provides downstream signals to PIN diode 32 and optical low pass filter 34 receives upstream signals from transmission laser 36. Laser 36 and diode 32 may be coupled to electrical diplexer 38, which in turn may be coupled to F-connector 40 for providing connectivity to an existing cable modem or other devices used in a home or office that is not wired for Ethernet or other similar high speed communication. Thus, ONI 24 may function as an optical/electrical interface between PON 8 shown in FIG. 1 and a building's CATV coaxial cable network. It will be appreciated that downstream traffic signals are preferably carried by a shorter wavelength that used for upstream traffic. However, this need not be the case, and downstream traffic signals may use longer wavelengths than upstream traffic signals.

Regarding the types of outputs from ONI 24, for a building that is already wired for Ethernet, or other high speed communication, or for a new construction installation, the ONI may include additional components that facilitate output of multiple types of signals. Laser 36 and diode 32 may be coupled to DOCSIS/interface circuitry 42 that may typically be found in a conventional DOCSIS cable modem device. DOCSIS/interface 42 includes QAM radio circuitry for modulating and demodulating signals upstream and downstream traffic to/from laser 36 and diode 32 respectively. In addition, DOCSIS/interface 42 includes DOCSIS circuitry for decoding DOCSIS data packets. The decoded DOCSIS data packets may be provided to the user at high-speed connection point 44 for coupling with a computer or other data device. Other devices may include a set top box that uses the DOCSIS data connection (from either 44 or 40) for messaging with video server 16 shown in FIG. 1. DOCSIS packets may also be used to carry telephony signals via voice over internet protocol (“VoP”). If so, these DOCSIS telephony packets would be output along with other DOCSIS packets from port 44. A receiving device, such as a computer or DOCSIS telephone would typically process the voice packets with an MTA.

VoIP packets may also be transported as MPEG-2 transport without DOCSIS header information. If so, they would be output at port 46 to media terminal adaptor (“MTA”) for interfacing with a telephone. It will be appreciated that MTA 48 may be included within ONI 24, and may even be included within DOCSIS/interface 42.

Digital video traffic streams may be output from connection port 50 to a digital input of an STB. Thus, an STB need not include a demodulator, as the demodulator circuitry of DOCSIS/interface 42 would perform this function. Analog video channels may be received at a television set connected to pass through port 52. An STB demodulator could also be connected to pass through connection 52 for receiving and demodulating analog, as well as digital television program streams.

DOCSIS/interface 24 may be used with the combined transmission device of U.S. patent application Ser. No. 10/982,211 regardless of whether the network used to connect the equipment at the user's premises and the head end equipment is an HFC or a PON. However, when PON 8 of FIG. 1 is used as the distribution network, an advantage is realized because coaxial cable may be significantly reduced or eliminated from the system. For example, by eliminating the HFC network, a major pathway of ingress noise is eliminated, with the result of increased upstream data transmission performance. Thus, the remaining coaxial cable in the system is typically the relatively short—as compared to the length of cable in an HFC network—piece connecting laser 36 and diode 32 to interface 42 when the optical related components and the interface are not incorporated within the same enclosure. This is also the case when ONI 24 is used as an optical interface and diplexer 38 is connected to a user's coaxial network. Since this coaxial length is much less than the length of cable making up an HFC network, there are significantly fewer entry points for ingress noise to be injected into the distribution plant.

Moreover, if optical diplexer 28 is incorporated into the same enclosure as laser 36, diode 32 and DOCSIS/interface 42, coaxial between the head end and the user's equipment is completely eliminated, with the exception of pass through downstream signals, which are not as susceptible to ingress noise as are upstream signals. Thus, using ONI 24 with a PON distribution network results in much improved data rates, especially in the upstream direction and the upper end of the downstream spectrum. It will be appreciated that by using a PON for distribution of DOCSIS signals, frequencies used for downstream, as well as upstream, can be extended beyond the typical downstream limit of about 750 to 800 MHz. This is because a PON has a much high natural roll-off frequency than an HFC, partly because of the nature of optical fiber and partly because there are no amplifiers. Furthermore, the performance of an optical system does not degrade with respect to time as rapidly as an HFC network, which may suffer from corrosion of connection, and mechanical connections becoming weak, for example. Accordingly, the QAM modulators and demodulators may be operated at higher frequencies, thereby providing for more available channels in which to carry traffic signals.

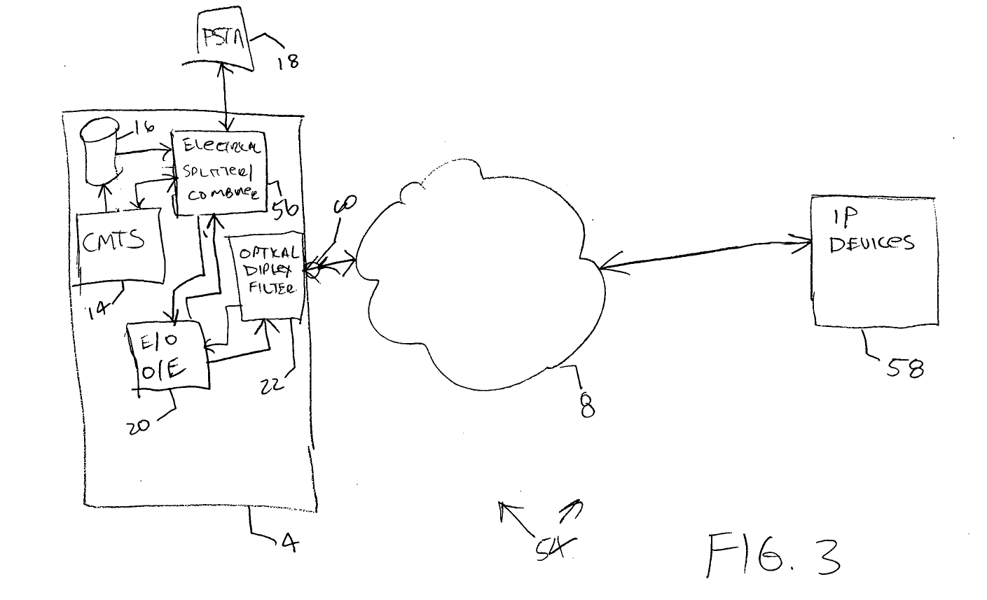

Although the desirable transfer function of a PON compared to an HFC plant provides a dramatic performance increase in transporting DOCSIS signals using QAM modulators, even greater performance may be realized using a PON. In addition to using QAM modulators/demodulators to transport packets, the embodiment shown in FIG. 3 illustrates a system 54 where DOCSIS media access control (“MAC”) circuitry is used with MPEG-2 transport, known in the art, to transport packets across a PON network. Eliminating QAM channels eliminates the 6 MHz bandwidth limitation of typically 30 Mbps for 256 QAQM, for example, and increases performance as fewer operations are required in analyzing packet's headers and because the process of tuning to a given channel and the frequency response of the radio circuits is eliminated. The primary difference as compared to system 2 shown in FIG. 1 and ONI 24 shown in FIG. 2, the splitter 56 shown in FIG. 3 uses a DOCSIS MAC and baseband physical layer circuitry (“PHY”) and software, as opposed to splitter/combiner 12, which uses a DOCSIS MAC but a DOCSIS PHY—including QAM modulator/demodulator. IP devices 58, which may be computers, STBs, telephones, and others, uses a DOCSIS MAC and baseband PHY as opposed to a DOCSIS MAC and DOCSIS PHY. Thus, many of the features of DOCSIS, such as, for example, security, messaging, quality of service (“QoS”), etc, are retained, but the limitation of the QAM radio circuitry is eliminated. Each IP device 58 has a unique IP address, and communication between these devices and the CMTS are based on IP addressing. It will be appreciated the time division multiplexing, or similar process, is still used in the upstream direction, since the every IP device 58 will be trying to communicate in the upstream direction with port 60 at the head end. Port 60 typically has a unique IP address, or other unique identifier, such as a UDP port identifier.

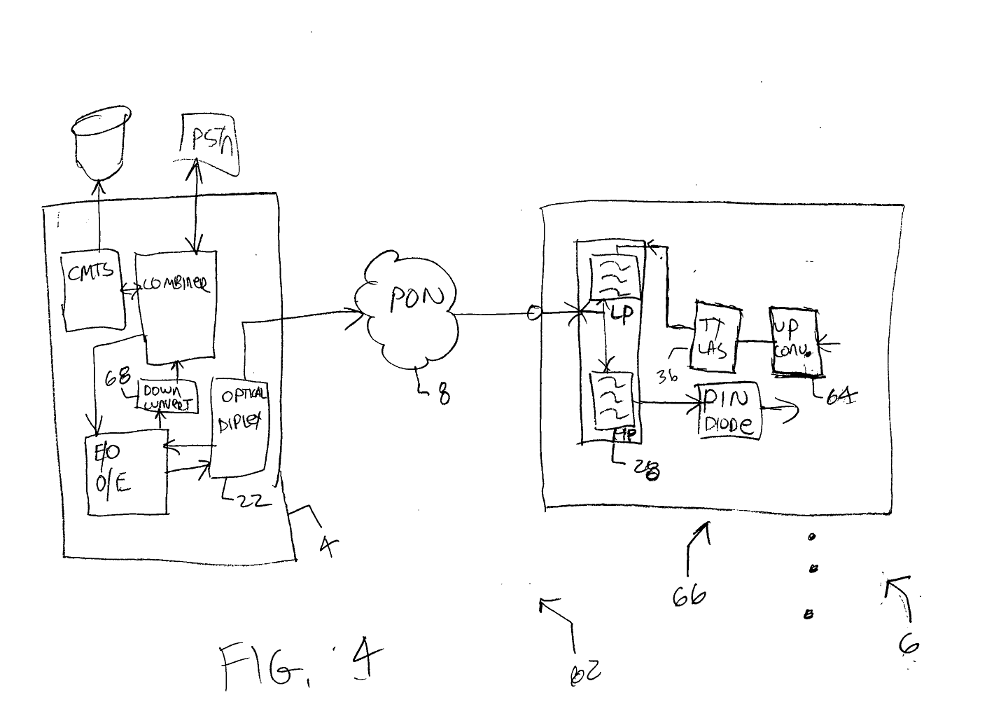

Turning now to FIG. 4, an embodiment 62 similar to what is illustrated in FIGS. 1 and 2 is shown where an upconverter 64 is used at cable modem, or other IP devices, 66 at subscriber's locations 6 to convert upstream traffic streams to a frequency that is higher than the standard DOCSIS 5 MHz to approximately 42 MHz. The traffic streams are transmitted across PON 8 to head end 4. At head end 4, a downconverter 68 is used to transform received upstream traffic signals from the higher frequencies back to the standard DOCSIS 5-42 MHz range. Thus, the upstream traffic signals received at CMTS 14 have carrier frequencies in the range the CMTS is configured for, and therefore, may not require redesign as compared to conventional circuitry. However, it will be appreciated that while upconverter 64 and downconverter 68 are represented as separate blocks, or circuitry, the function of upconverting may preferably be implemented by simply designing the front end stages of the transmitter and receiver circuits at the devices at the subscriber's premises and the head end respectively to operate at higher frequencies than 5-42 MHz.

Thus, blocks 64 and 68 may not necessarily represent separate and/or additional components, but merely that the typical radio circuits found in conventional subscriber DOCSIS equipment and head end equipment may be designed to operate at upstream frequencies higher than the conventional 5-42 MHz upstream DOCSIS frequencies. It is noted that these frequencies referred to herein are representative of a nominal upstream frequency range, and that a given operator or given equipment vendor may conventionally use or provide equipment that operates at frequencies different from these.

It is further noted that the upstream frequencies that may be used in system 62 may be selected by the operator. The operator may choose to provide upstream traffic from 5-125 MHz, for example. Thus, the conventional upstream frequency range would be extended beyond the standard 42 MHz. Alternatively, an operator may choose a frequency scheme that surrounds an upstream frequency range with downstream frequency ranges below and above the upstream range. Or, the upstream frequency range may be placed above a set of contiguous downstream frequencies.

It will be appreciated that if such alternative frequency range schemes were implemented in an HFC network, special filtering, such as crossover filters, notch filters, bandpass filters, etc., would typically be used to separate upstream from downstream carrier frequencies. However, by using PON 8 for the distribution network, implementing alternative frequency schemes is simplified because upstream traffic will be transmitted toward the head end at an upstream wavelength and downstream traffic will be transmitted from the head end at a downstream wavelength. Thus, the optical diplexers 22 and 28 at the head end and subscriber device(s) respectively, only need to separate one wavelength from another and forward the signals in the appropriate direction to the corresponding appropriate circuitry.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

1. A system for transporting over a PON a plurality of traffic signals of a plurality of service types between head end equipment and a user device, comprising:
means for combining electrical traffic signals of a plurality of service types into a composite electrical signal; and
means for converting the composite electrical signal into a composite optical signal at a predetermined wavelength and impressing said composite optical signal into a PON.

2. The system of claim 1 wherein the PON includes at least one means for splitting the composite optical signal into a corresponding plurality of distribution optical fibers, wherein the splitting means is also capable of combining optical signals into a composite signal.

3. The system of claim 1 further comprising a means for separating composite optical signals at a downstream wavelength from optical composite signals at a upstream wavelength.

4. The system of claim 3 wherein the means for separating is an optical diplexer.

5. The system of claim 1 wherein the means for combining electrical signals of a plurality of services types into a composite electrical signal is a combined transmission device.

6. The system of claim 1 wherein the means for converting the composite electrical signal into a composite optical signal is a laser.

7. The system of claim 1 wherein the plurality of service types includes video content from a video server.

8. The system of claim 1 wherein the plurality of service types includes DOCSIS data.

9. The system of claim 7 wherein the plurality of service types includes DOCSIS data, and wherein DOCSIS data is used for messaging between a user device and the video server.

10. The system of claim 1 wherein the head end equipment is coupled to PSTN equipment to provide telephony service traffic signals over the PON.

11. The system of claim 1 wherein the electrical signals are QAM signals.

12. The system of claim 11 wherein upstream signals are carried by channels having carrier frequencies below 42 MHz and downstream signals are carried by channels having carrier frequencies above 42 MHz.

13. The system of claim 11 wherein upstream signals are carried by channels having carrier frequencies above 42 MHz.

14. The system of claim 1 wherein the electrical signals are baseband signals.

15. A system for transporting over a PON a plurality of traffic signals of a plurality of service types between head end equipment and a user device, comprising:
means for receiving and converting a composite optical signal from the PON at a downstream wavelength into a composite electrical signal, wherein the composite optical signal includes a plurality of traffic signals; and
means for separating the plurality of traffic signals from the composite electrical signal into a plurality of signals according to service type and directing said traffic signals to corresponding circuitry according to service type, wherein the separating means is coupled to the receiving means.

16. The system of claim 15 further comprising a means for converting a composite electrical signal into a composite optical signal and for impressing said composite optical signal to the PON at an upstream wavelength.

17. The system of claim 16 further comprising an MTA for providing VoIP service.

18. The system of claim 16 further comprising a means for separating composite optical signals at a downstream wavelength from optical composite signals at an upstream wavelength.

19. The system of claim 18 wherein the means for separating is an optical diplexer.

20. The system of claim 15 wherein the electrical signals are QAM signals.

21. The system of claim 20 wherein upstream signals are carried by channels having carrier frequencies below 42 MHz and downstream signals are carried by channels having carrier frequencies above 42 MHz.

22. The system of claim 20 wherein upstream signals are carried by channels having carrier frequencies above 42 MHz.

23. The system of claim 15 wherein the electrical signals are baseband signals.
